(19) United States
(12) Patent Application Publication
(10) Pub. No.: US 2026/0188315 A1
(43) Pub. Date: Jul. 2, 2026

(54) INFORMATION PROCESSING DEVICE

(71) Applicant: TOYOTA JIDOSHA KABUSHIKI KAISHA, Toyota-shi (JP)

(72) Inventors: Aya YAMADA KAMISAKA, Tokyo (JP); Hajime TOJIKI, Tokyo (JP); Ryota NAKANISHI, Tokyo (JP); Kota HOSHIBA, Tokyo (JP); Takayuki YAMABE, Tokyo (JP)

(73) Assignee: TOYOTA JIDOSHA KABUSHIKI KAISHA, Toyota-shi (JP)

(21) Appl. No.: 19/347,734

(22) Filed: Oct. 2, 2025

(30) Foreign Application Priority Data
Dec. 26, 2024 (JP) 2024-230776

(51) Int. Cl. G10L 15/22; B60K 35/26

(52) U.S. Cl. CPC G10L 15/22; B60K 35/26

(57) ABSTRACT

An information processing device includes a control unit configured to: acquire an utterance made by a user; determine, based on the utterance, one or more external agents to which the utterance is to be forwarded, from among a plurality of external agents each configured to engage in natural language dialogue and specialized in a corresponding one of a plurality of predetermined domains; forward the utterance to the one or more external agents and acquire one or more responses from the one or more external agents; and integrate the one or more responses and provide a response obtained by integrating the one or more responses to the user.

### CROSS-REFERENCE TO RELATED APPLICATION

This application claims priority to Japanese Patent Application No. 2024-230776 filed on Dec. 26, 2024. The disclosure of the above-identified application, including the specification, drawings, and claims, is incorporated by reference herein in its entirety.

### BACKGROUND

### 1. Technical Field

The present disclosure relates to dialogue technology.

### 2. Description of Related Art

There is technology for conducting natural language dialogue based on an input sentence. In this regard, for example, Japanese Unexamined Patent Application Publication No. 2021-182051 (JP 2021-182051 A) discloses a device capable of engaging in dialogue with a plurality of agents via a network.

### SUMMARY

With the advancement of machine learning, services that provide natural language dialogue are expected to become increasingly widespread.

An object of the present disclosure is to provide highly accurate dialogue.

One aspect of an embodiments of the present disclosure is an information processing device including a control unit configured to: acquire an utterance made by a user; determine, based on the utterance, one or more external agents to which the utterance is to be forwarded, from among a plurality of external agents each configured to engage in natural language dialogue and specialized in a corresponding one of a plurality of predetermined domains; forward the utterance to the one or more external agents and acquire one or more responses from the one or more external agents; and integrate the one or more responses and provide a response obtained by integrating the one or more responses to the user.

Other aspects include a method that is executed by the above device, a program that causes a computer to execute the method, and a computer-readable storage medium that stores the program in a non-transitory manner.

The present disclosure can provide highly accurate dialogue.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic diagram of a dialogue system with a conventional configuration;

FIG. 1B is a schematic diagram of the dialogue system with another configuration;

FIG. 1C is a schematic diagram of a dialogue system according to a first embodiment;

FIG. 2 shows a hardware configuration of an in-vehicle device 10;

FIG. 3 shows a software configuration of the in-vehicle device 10;

FIG. 4 shows the flow of processing executed by the control unit 11 of the in-vehicle device 10.

FIG. 5A shows an example of prompt text;

FIG. 5B shows an example of a response;

FIG. 5C shows an example of a response;

FIG. 5D shows an example of a response text; and

FIG. 6 is a flowchart of the processing executed by the control unit 11 of the in-vehicle device 10.

### DETAILED DESCRIPTION OF EMBODIMENTS

In recent years, with the advancement of machine learning, the number of

products incorporating language models has been increasing. For example, it is possible to add a natural language dialogue function to a target product by incorporating into the product a large language model (LLM) trained on a large-scale dataset for improved accuracy.

An example in which natural language dialogue is useful is an automobile. For example, by incorporating an LLM into an in-vehicle device, it becomes possible to obtain information without operating a touch panel etc. Such a function is particularly useful when the user's hands are occupied, such as while driving.

On the other hand, a trained LLM has a large model size, which makes it difficult to install it on embedded devices due to cost. Therefore, methods have been devised for accessing the LLM via a network. Accessing the LLM via a network enables the use of a large-scale language model that is too large to be stored in local storage.

The use of a network enables selective access to domain-specific LLMs. For example, when multiple domain-specific LLMs are provided such as an LLM specialized in route guidance, an LLM specialized in regional information guidance, and an LLM specialized in casual conversation, the use of a network enables selection of an LLM relevant to the user's intent. In this regard, a technique is known in which the category of a user's utterance is determined based on the content of the utterance, and an LLM relevant to the category is automatically selected.

However, when one LLM is selected from among multiple LLMs to conduct dialogue, the dialogue may be limited to the specific domain in which the selected LLM is specialized.

For example, when a user's utterance includes content such as “The warning light in the car turned on,” and an LLM specialized in vehicle operation guidance is selected, it is expected that information regarding the meaning of the warning light will be provided in response to the utterance. However, an LLM specialized in vehicle operation guidance may not have access to regional information, and therefore may be unable to provide services such as guiding the user to the nearest car dealership for inspection.

One approach to addressing this issue is to forward the user's utterance to a plurality of LLMs and integrate the responses obtained from them.

The information processing device according to the present disclosure addresses such an issue.

An information processing device according to a first aspect of the present disclosure includes a control unit configured to: acquire an utterance made by a user; determine, based on the utterance, one or more external agents to which the utterance is to be forwarded, from among a plurality of external agents each configured to engage in natural language dialogue and specialized in a corresponding one of a plurality of predetermined domains; forward the utterance to the one or more external agents and acquire one or more responses from the one or more external agents; and integrate the one or more responses and provide a response obtained by integrating the one or more responses to the user.

Each of the plurality of external agents includes a language model configured to engage in natural language dialogue and specialized in intent understanding in a corresponding one of the domains. The language model may be a large language model (LLM). A large language model is, for example, a language model trained to be capable of performing natural language dialogue tasks. Examples of the domains include route guidance, regional information guidance, vehicle operation guidance, tourist guidance, and casual conversation. These agents are typically configured to be remotely accessible via a network.

The control unit determines one or more external agents to which an utterance made by a user is to be forwarded, and acquires responses from the determined external agents. The control unit may transmit, via a network, prompt text including the content (utterance text) of the utterance made by the user to the determined external agents. One or more responses can thus be acquired from each of the determined external agents.

The control unit integrates the one or more responses acquired from the determined external agents and provides the integrated response to the user. The integration of the responses may be performed using either a rule-based approach or another language model. For example, the integration of the responses may be performed by inputting the responses obtained from the determined external agents to an agent that operates locally and includes a language model (i.e., a local agent).

The language model included in the local agent is a language model capable of performing natural language dialogue tasks, but may be a relatively low-cost language model that has not been trained for any specific domain.

With this configuration, it becomes possible to acquire information from a plurality of LLMs specialized in various domains and to integrate such information and provide the integrated information to the user.

In the example mentioned above, for instance, it becomes possible to provide guidance on the meaning of the warning light and, at the same time, guide the user to a service location capable of resolving the issue, by integrating a response obtained from an LLM specialized in vehicle operation guidance and a response obtained from an LLM specialized in providing regional information.

The control unit may be configured to also acquire context information corresponding to the user and input the acquired context information to the one or more external agents to which the utterance is to be forwarded.

Examples of the context information corresponding to the user include attribute information of the user and information on the user's movement. The attribute information of the user may include, for example, the user's age, gender, and preferences. The information on the user's movement may include, for example, the destination or route information of a vehicle in which the user is riding (i.e., a vehicle in which the information processing device according to the present disclosure is mounted).

Hereinafter, specific embodiments of the present disclosure will be described with reference to the drawings. The hardware configurations, module configurations, functional configurations, etc. described in the embodiments are not intended to limit the technical scope of the disclosure to only those examples, unless otherwise specified.

### First Embodiment

### System Overview

An overview of a dialogue system according to a first embodiment will be described. The dialogue system according to the present embodiment includes an in-vehicle device 10 mounted in a vehicle. The in-vehicle device 10 can access, via a network (e.g., a mobile communication network), an agent (external agent) that provides a dialogue service in natural language.

The in-vehicle device 10 is mounted in a connected vehicle capable of communicating with any desired device via wireless communication. The in-vehicle device 10 may include a data communication module (DCM) for connecting components of the vehicle (e.g., an electronic control unit (ECU) and an in-vehicle terminal) to a network. In the present embodiment, the in-vehicle device 10 can access the Internet via a predetermined mobile communication network and connect to agents etc. that provide dialogue services.

The vehicle (or components mounted in the vehicle) can provide various services by communicating with external devices via the in-vehicle device 10. Examples of such services include navigation services, remote control services (e.g., remote air conditioning), in-vehicle Wi-Fi (registered trademark) services, and emergency call services.

The in-vehicle device 10 also has a voice input and output function and is capable of engaging in natural language dialogue with an occupant of the vehicle.

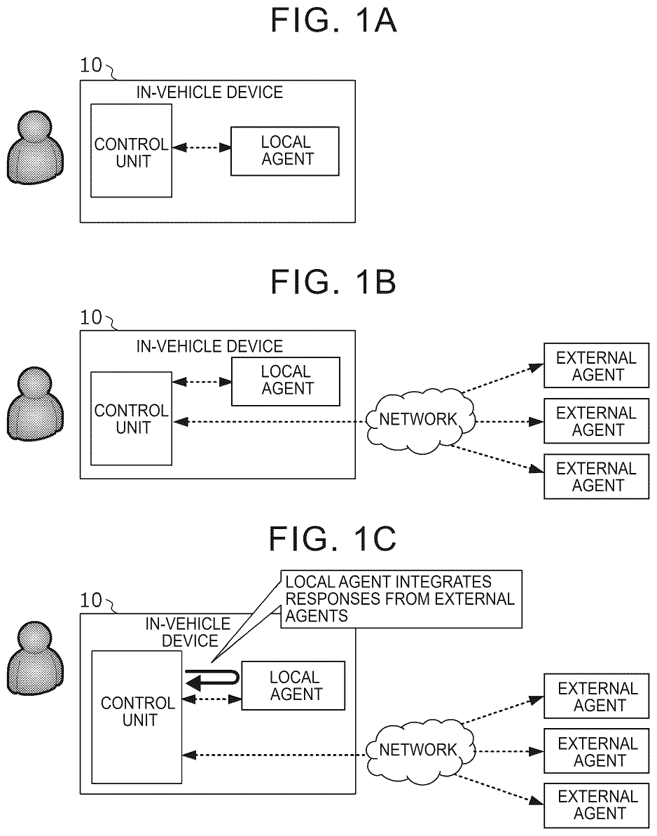

FIG. 1A is a schematic diagram illustrating the in-vehicle device 10 with a conventional configuration.

The in-vehicle device 10 includes a control unit and a local agent. The control unit is configured to perform voice input and output and speech recognition. The local agent includes a language model trained to enable natural language dialogue. For example, the local agent may provide a predetermined function such as route search or vehicle operation (e.g., air conditioning) through dialogue. In the illustrated configuration, the language model used by the local agent is stored in a storage device included in the in-vehicle device 10.

On the other hand, in such a configuration, it is difficult to provide a dialogue service using a large-scale language model. For example, there are a wide variety of dialogue categories, including regional information, tourist information, vehicle-related information (e.g., operation manuals), and casual conversation. To cover all of these categories, it is necessary to prepare a language model trained on a large-scale dataset. Such language models may range in size from several gigabytes to several hundred gigabytes, and storing them in local storage is not realistic from a cost perspective.

Accordingly, systems have been proposed in which a language model specialized in dialogue in a specific domain is accessed via a network.

FIG. 1B is a schematic diagram of a configuration in which the in-vehicle device 10 can access not only a local agent but also a plurality of language models provided over the Internet. For example, agents (external agents), each equipped with a domain-specific large language model, may be deployed on devices connected to the Internet, and the in-vehicle device 10 may access the agents upon request.

However, in this configuration, dialogue is limited to a specific domain. For example, when the user wishes to obtain information about a particular sport, it is expected that the user will interact with an agent specialized in that sport. However, since this agent lacks information unrelated to the sport, such as venue information, this agent is unable to, for example, guide the user to a venue where the user can watch the sport.

Accordingly, in the in-vehicle device 10 of the present embodiment, the local agent is provided with a function to integrate responses from a plurality of external agents. The user's utterance is forwarded to a plurality of external agents, and responses are obtained from those external agents. These responses are integrated by the local agent, and the integrated response is provided to the user. FIG. 1C is a schematic diagram of the in-vehicle device 10 according to the present embodiment.

When the in-vehicle device 10 recognizes the user's utterance, it determines, based on the content of the utterance, which external agent (or external agents) is relevant to the utterance. This process may be performed using either a rule-based approach or another language model. The control unit also forwards the utterance to the determined external agent (or external agents).

Responses from the determined external agents are integrated by the local agent, and the integrated response is provided to the user.

This configuration makes it possible to appropriately provide responses obtained from a plurality of external agents to the user.

In the description of the present embodiment, the expressions “access an external agent” and “connect to an external agent” refer to accessing or connecting to an external device that provides a dialogue service via the external agent. In the present embodiment, each of a plurality of dialogue services using large language models is operating as an “external agent” on a corresponding one of a plurality of external devices, and the in-vehicle device 10 can engage in dialogue by connecting to any of these external agents.

### Hardware Configuration

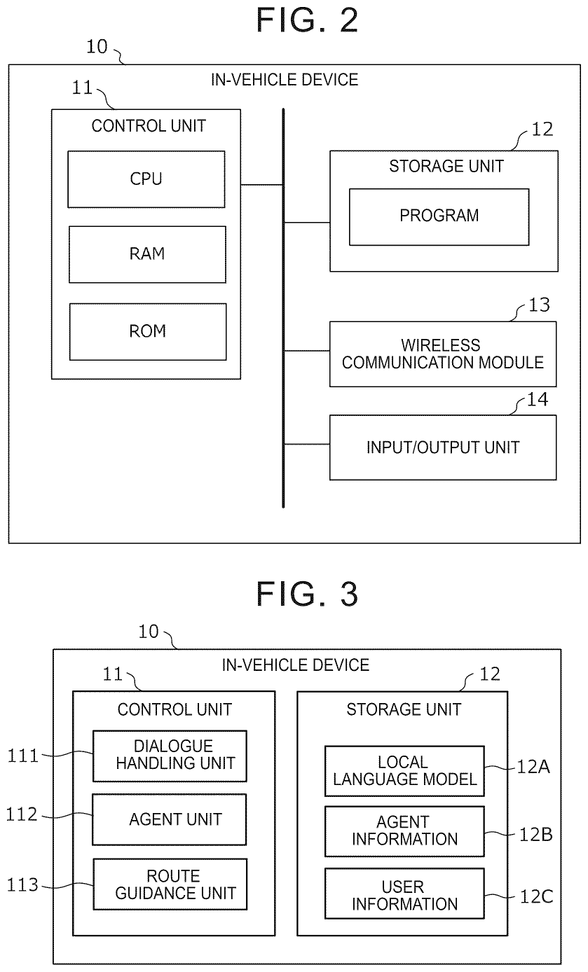

Next, the hardware configuration of the devices constituting the system will be described. FIG. 2 schematically shows an example of the hardware configuration of the in-vehicle device 10 according to the present embodiment.

The in-vehicle device 10 may be configured as a computer including a processor (e.g., a central processing unit (CPU) or a graphics processing unit (GPU)), a main storage device (e.g., a random access memory (RAM) or a read-only memory (ROM)), and an auxiliary storage device (e.g., an erasable programmable read-only memory (EPROM), a hard disk drive, or a removable medium). The auxiliary storage device stores an operating system (OS), various programs, various tables, etc., and various functions (software modules) that serve predetermined purposes, as described below, can be implemented by executing the programs stored in the auxiliary storage device. However, some or all of the modules may be implemented as hardware modules using hardware circuits such as application-specific integrated circuits (ASICs) or field programmable gate arrays (FPGAs).

The in-vehicle device 10 includes, as hardware components, a control unit 11, a storage unit 12, a wireless communication module 13, and an input/output unit 14.

The control unit 11 is a processing unit that implements various functions of the in-vehicle device 10 by executing predetermined programs. The control unit 11 may be implemented by, for example, a hardware processor such as a CPU. The control unit 11 may also include a RAM, a ROM, a cache memory, etc.

The storage unit 12 is means for storing information, and is configured using a storage medium such as a RAM, a magnetic disk, or a flash memory. The storage unit 12 stores programs to be executed by the control unit 11, data to be used by the programs, etc.

The wireless communication module 13 is a communication device that performs wireless communication with a predetermined network. In the present embodiment, the wireless communication module 13 is configured to communicate with a predetermined mobile communication network. The wireless communication module 13 may include an embedded Universal Integrated Circuit Card (eUICC) (e.g., a Subscriber Identity Module (SIM) card). The SIM card is configured as a microcomputer that includes a CPU and a storage device. The SIM card stores information for connecting to the mobile communication network and receiving authentication.

The input/output unit 14 is a unit that receives input from the user of the device and presents information to the user. The input/output unit 14 typically includes devices that input and output voice, such as a microphone and a speaker. The input/output unit 14 may also include a device that provides visual information (e.g., a display).

### Software Configuration

Next, the software configuration of the devices constituting the system will be described. FIG. 3 schematically shows an example of the software configuration of the in-vehicle device 10 according to the present embodiment.

In the present embodiment, the control unit 11 of the in-vehicle device 10 includes three software modules: a dialogue handling unit 111, an agent unit 112, and a route guidance unit 113. Each software module may be implemented by executing a program stored in the storage unit 12 using the control unit 11 (e.g., a CPU). The information processing performed by the software modules is synonymous with the information processing performed by the control unit 11 (e.g., a CPU).

The dialogue handling unit 111 acquires an utterance made by a vehicle occupant (hereinafter also referred to as “user”) via the input/output unit 14. The dialogue handling unit 111 performs predetermined processing on the acquired voice data and performs speech recognition. The content of the utterance is thus converted into text. The dialogue handling unit 111 then sends the text obtained through the speech recognition to the agent unit 112.

The dialogue handling unit 111 also outputs a response (hereinafter referred to as “response text”) from the language model sent by the agent unit 112. The dialogue handling unit 111 converts the response text into speech and outputs it via the input/output unit 14.

The agent unit 112 first provides a dialogue service using a language model stored in the device (a local language model 12A, described later). The agent unit 112 can function as a virtual agent (local agent). The local agent can provide, for example, a dialogue service that can be completed within the device (e.g., casual conversation).

When the dialogue involves specialized knowledge, the agent unit 112 forwards the utterance to one or more external agents available via the network and obtains the results. For example, when it is determined that the user is seeking information on the vehicle, the agent unit 112 selects an external agent capable of providing vehicle operation guidance. When it is determined that the user is seeking information on facilities or stores, the agent unit 112 selects an external agent capable of providing regional information.

The selection of the external agent may be based on the result of analyzing the content of the utterance. For example, the agent unit 112 may calculate a relevance score for each of the plurality of external agents based on words included in the utterance of the context of the utterance, and forward the utterance to an external agent whose relevance score is greater than or equal to a predetermined value.

The agent unit 112 may select multiple external agents to which the utterance is to be forwarded. For example, when there are multiple external agents whose relevance scores to the utterance are greater than or equal to the predetermined value, the agent unit 112 may forward the utterance to these external agents. In this case, the agent unit 112 obtains responses to the utterance from these external agents, integrates the responses, and provides the integrated response to the user.

The route guidance unit 113 receives a designation of a departure point and a destination from the user, and generates a route connecting the designated departure point and destination based on road map data etc. The route guidance unit 113 also outputs information on the generated route via the input/output unit 14.

The storage unit 12 of the in-vehicle device 10 stores a local language model 12A, agent information 12B, and user information 12C.

The local language model 12A is a language model trained to enable natural language dialogue tasks. The local language model 12A is a relatively low-cost language model that has not been trained to perform domain-specific dialogue. The local language model 12A may be any language model capable of engaging in general-purpose conversation. For example, an open-source language model may be used as the local language model 12A.

The local language model 12A is a lightweight language model compared to the large language models held by the external agents accessible via the network. The use of the local language model 12A by the agent unit 112 enables responsive dialogue. It is thus possible to selectively use external and local agents. For example, utterances involving specialized conversation can be forwarded to external agents, while utterances in conversations where a quick response is expected can be handled by the local agent.

The agent information 12B is a set of data on the plurality of external agents available to the in-vehicle device 10. The agent information 12B may include, for example, the identifiers and names of the external agents, information on the domains in which the external agents are specialized, and information on access destinations (e.g., the network addresses of external devices that provide the external agents). The agent unit 112 can determine the destination to which the utterance is to be forwarded by referring to the agent information 12B.

The user information 12C is a set of data on the attributes of the user who interacts with the in-vehicle device 10. The user information 12C may include, for example, information on the user's preferences, and personal information such as the user's gender, age, height, and weight. When there are multiple users of the vehicle, the user information 12C may include data for these users.

### Dialogue Flow

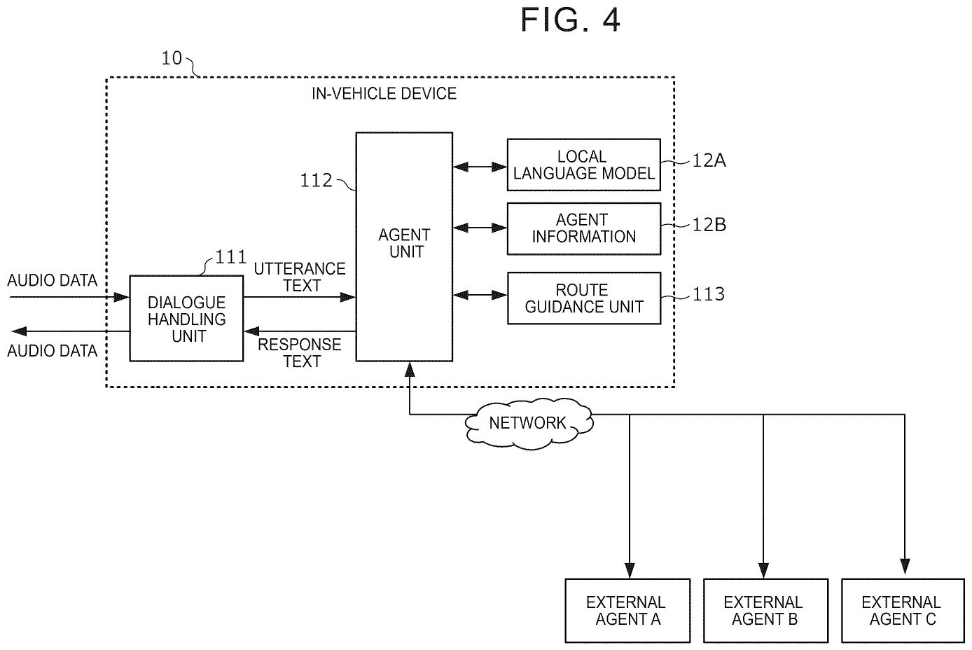

Next, an overview of the processing executed by the control unit 11 will be described. FIG. 4 shows the flow of processing executed by the control unit 11 of the in-vehicle device 10 after receiving an utterance from the user.

The dialogue handling unit 111 acquires an utterance from the user via the input/output unit 14. For example, the input/output unit 14 converts the utterance acquired through a microphone etc. into audio data, and the dialogue handling unit 111 acquires the audio data. The dialogue handling unit 111 performs predetermined speech recognition processing on the acquired audio data to convert the audio data into text. While holding the response to the utterance, the dialogue handling unit 111 transmits the text obtained through the speech recognition to the agent unit 112. This text is hereinafter referred to as “utterance text.”

Upon receiving the utterance text, the agent unit 112 determines the intent of the utterance (what the user is requesting) and the user's situation (what the user is currently doing) based on the content of the utterance, and determines an external agent (or external agents) to which the utterance text is to be forwarded. The intent of the utterance may be determined using the local language model 12A or another machine learning model. The intent of the utterance may alternatively be determined using a rule-based approach. The user's situation may be determined using sensor data in addition to the utterance. For example, the agent unit 112 may use data acquired from sensors mounted in the vehicle, such as vehicle speed, current location, and direction of travel, in addition to the utterance to determine the user's situation. Examples of the user's situation include “traveling on an ordinary road,” “traveling on a highway,” “temporarily stopped,” “waiting at a traffic light,” “commuting to work,” or “returning home.”

The agent unit 112 acquires information on the external agents (agent information 12B) from the storage unit 12, and determines an external agent (or external agents) to which the utterance text is to be forwarded, based on the agent information 12B and the determined intent and situation. For example, the agent unit 112 may calculate a relevance score for each of the plurality of external agents and determine to forward the utterance to an external agent (or external agents) whose relevance score is greater than or equal to the predetermined value.

In this example, it is assumed that the following four external agents are available.

### (1) Vehicle Agent

An external agent capable of recognizing the in-vehicle situation and configuring in-vehicle devices. This agent has been trained on the vehicle owner's manual and is also capable of providing information on the functions of the vehicle.

### (2) Chat Agent

An external agent specialized in non-task-oriented casual conversation.

### (3) Regional Information Agent

An external agent capable of providing regional information including information on local stores and tourist information.

In this example, it is assumed that the vehicle agent and the regional information agent have been selected as the external agents relevant to the utterance.

The agent unit 112 may determine not to forward the utterance to any external agent. This applies to, for example, cases where the user's request can be handled entirely within the device, such as when the user's request involves route guidance, or cases where a quick response is preferred. In such cases, the utterance text is processed by the agent unit 112 (and the local language model 12A).

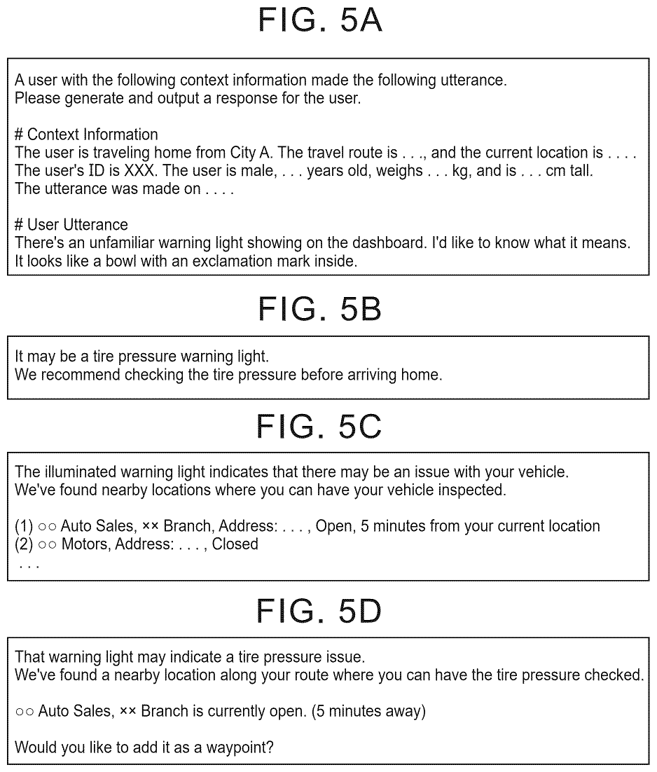

The agent unit 112 then generates prompt text to be input to the selected external agents. FIG. 5A shows an example of the prompt text input from the agent unit 112 to the external agents.

The prompt text includes not only the utterance text but also context information corresponding to the user.

In the present embodiment, the context information refers to attribute information of the user and information on the user's movement. The context information may include, for example, information on the user's preferences, and personal information such as the user's gender, age, height, and weight. These pieces of information may be obtained from the user information 12C stored in the storage unit 12.

The context information may also include information on the user's movement. Examples of such information include information on the vehicle's departure point, destination, travel route, and waypoints. These pieces of information may be obtained from the route guidance unit 113.

The agent unit 112 forwards the generated prompt text via the network to the external devices each providing a corresponding one of the desired external agents.

Each external agent to which the utterance text is input outputs a response to the utterance text. FIG. 5B shows an example of a response from the vehicle agent, and FIG. 5C shows an example of a response from the regional information agent. As shown in the figures, each external agent outputs a response related to the domain in which it is specialized. For example, the vehicle agent outputs information on the specific meaning of the warning light, and the regional information agent outputs information on locations where the vehicle can be inspected.

Upon receiving responses from the external agents to which the utterance text was forwarded, the local language model 12A integrates the responses and sends the result to the dialogue handling unit 111 as a response text. FIG. 5D shows an example of a response text obtained through the integration.

The integration of the responses may be performed using the local language model 12A. For example, the agent unit 112 may input a prompt text including one or more received responses to the local language model 12A to cause it to perform the integration. The prompt text includes, for example, an instruction to generate a new sentence by integrating the content of the responses obtained from the external agents. As a result, an integrated response text is output from the local language model 12A. The integrated response text is then sent from the agent unit 112 to the dialogue handling unit 111.

When the dialogue handling unit 111 receives the response text, it generates audio data based on the response text, and outputs the audio data via the input/output unit 14. The dialogue handling unit 111 may generate the audio data for reading out the response text, or may additionally generate information accompanying the audio data. An example of the information accompanying the audio data is a user interface screen. The user interface screen may include the response text in written form.

The dialogue system according to the present embodiment seamlessly performs the series of processes shown in FIG. 4. This gives the user who made the utterance the impression that he or she is interacting with the in-vehicle device 10.

### Flowchart

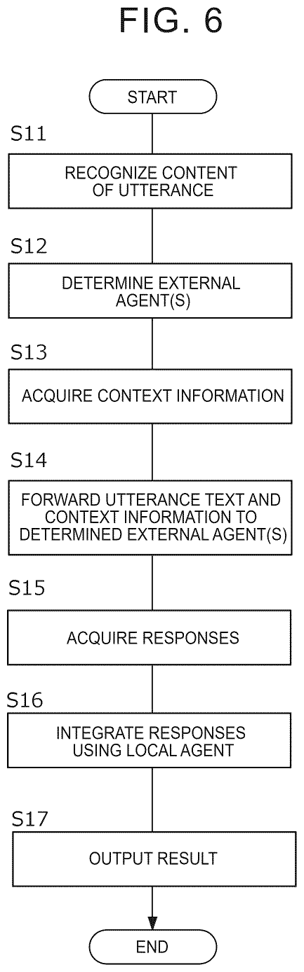

Next, the processing executed by the in-vehicle device 10 will be described in detail. FIG. 6 is a flowchart of the processing executed by the in-vehicle device 10. The processing shown in FIG. 6 starts when a user (an occupant of the vehicle) makes an utterance. The start of the utterance may be detected by, for example, a predetermined keyword.

First, in step S11, the dialogue handling unit 111 recognizes the content of the utterance. The dialogue handling unit 111 acquires audio data output from the input/output unit 14 and performs speech recognition processing on the audio data to convert the utterance to text. The converted text (utterance text) is sent to the agent unit 112.

In step S12, the agent unit 112 determines an external agent (or external agents) to which the utterance text and context information are to be forwarded. The external agent (or external agents) to which the utterance text and the context information are to be forwarded may be determined by, for example, estimating the user's intent (what the user is requesting) and situation (what the user is currently doing) from the utterance text, and making the determination based on the estimation results.

For example, the agent unit 112 may read information on the characteristics of the external agents (agent information 12B) from the storage unit 12 and determine an external agent (or external agents) to use based on this information.

Next, in step S13, the agent unit 112 acquires the user's context information. When the context information is information on the user's movement, the information may be acquired from the route guidance unit 113. When the context information is attribute information of the user, the information (user information 12C) may be acquired from the storage unit 12.

In step S14, the agent unit 112 forwards the utterance text and the context information to the external agent (or external agents) determined in step S12. For example, the agent unit 112 may access, via the wireless communication module 13, an external device (or external devices) providing the service of the target external agent (or external agents), and forward the utterance text and the context information to the target external agent (or external agents).

In step S15, the agent unit 112 acquires responses from the target external agent (or external agents).

In step S16, the agent unit 112 integrates these responses using the local language model 12A. Specifically, the agent unit 112 generates prompt text that includes a list of responses acquired from the multiple external agents and an instruction to integrate these responses, and inputs the prompt text to the local language model 12A. The agent unit 112 then acquires the integrated response text output from the local language model 12A.

In step S17, the agent unit 112 sends the response text obtained through the integration to the dialogue handling unit 111. The dialogue handling unit 111 generates audio data based on the response text and outputs the audio data via the input/output unit 14. The dialogue handling unit 111 may convert the response text into audio data using speech synthesis technology. The audio data is output via the input/output unit 14 (e.g., a speaker) and presented to the user.

As described above, in the in-vehicle device 10 according to the present embodiment, the local agent determines which external agent (or external agents) the utterance made by the occupant of the vehicle should be forwarded to. The local agent also integrates the responses obtained from the external agents and outputs the resultant response text. This configuration makes it possible to collectively provide the user with responses obtained from multiple external agents that handle highly specialized topics.

### Modifications

The above embodiment is merely illustrative, and the present disclosure may be modified as appropriate without departing from its spirit and scope.

For example, the processes and means described in the present disclosure may be combined as desired, as long as no technical inconsistencies arise.

The above embodiment illustrates an example in which external agents are deployed on external devices connected to the Internet. However, the external agents may instead be deployed on other types of devices. For example, the external agents may be deployed on an edge server accessible from the vehicle. The external agents may alternatively be distributed across a plurality of edge servers or clouds.

The above embodiment illustrates an in-vehicle device. However, the information processing device according to the present disclosure may be implemented as a device or equipment that is not mounted in a vehicle.

When the external agents are deployed across a plurality of edge servers or the like, the in-vehicle device 10 may acquire the location information of the vehicle and identify, based on the location information, the edge server on which the desired external agent is deployed. For example, external agents that provide regional information may be deployed on a plurality of edge servers each located in a different area. In such a case, the in-vehicle device 10 may identify the external agent deployed on the geographically closest edge server based on the location information of the vehicle. The regional information handled by the external agents may differ from one edge server to another. For example, an external agent that provides regional information for Area A may be deployed on an edge server located in Area A, and an external agent that provides regional information for Area B may be deployed on an edge server located in Area B. The in-vehicle device 10 can obtain regional information for the area in which the vehicle is located by identifying the edge server corresponding to that area and accessing the external agent provided by that edge server.

The processing described as being performed by a single device may instead be distributed across a plurality of devices. Alternatively, the processing described as being performed by different devices may be performed by a single device. In a computer system, the hardware configuration (server configuration) used to implement each function can be flexibly changed.

The present disclosure may also be implemented by supplying a computer with a computer program that implements the functions described in the above embodiment, and causing one or more processors included in the computer to read and execute the program. Such a computer program may be provided to the computer via a non-transitory computer-readable storage medium connectable to a system bus of the computer, or may be provided to the computer via a network. The non-transitory computer-readable storage medium may include any type of disk such as a magnetic disk (e.g., floppy (registered trademark) disk, hard disk drive (HDD)) and an optical disk (e.g., compact disc read-only memory (CD-ROM), digital versatile disc (DVD), Blu-ray disc), a read-only memory (ROM), a random access memory (RAM), an erasable programmable read-only memory (EPROM), an electrically erasable programmable read-only memory (EEPROM), a magnetic card, a flash memory, an optical card, and any type of medium suitable for storing electronic instructions.

What is claimed is:

1. An information processing device comprising a control unit configured to
acquire an utterance made by a user,
determine, based on the utterance, one or more external agents to which the utterance is to be forwarded, from among a plurality of external agents each configured to engage in natural language dialogue and specialized in a corresponding one of a plurality of predetermined domains,
forward the utterance to the one or more external agents and acquire one or more responses from the one or more external agents, and
integrate the one or more responses and provide a response obtained by integrating the one or more responses to the user.

2. The information processing device according to claim 1, wherein the control unit is configured to also acquire context information corresponding to the user and send the acquired context information to the one or more external agents to which the utterance is to be forwarded.

3. The information processing device according to claim 2, wherein the context information includes attribute information of the user or information on movement of the user.

4. The information processing device according to claim 2, wherein the context information includes destination or route information of a vehicle in which the information processing device is mounted.

5. The information processing device according to claim 1, wherein the control unit is configured to integrate the one or more responses by inputting the one or more responses to a local agent configured to engage in natural language dialogue.
